(19) United States
(12) Patent Application Publication
(10) Pub. No.: US 2011/0077756 A1
(43) Pub. Date: Mar. 31, 2011

(54) METHOD FOR IDENTIFYING AND PLAYING BACK AN AUDIO RECORDING

(75) Inventors: Anna JAKOBSSON, Lund (SE); Eral FOXENLAND, Malmo (SE)

(73) Assignee: Sony Ericsson Mobile Communications AB, Lund (SE)

(21) Appl. No.: 12/570,512

(22) Filed: Sep. 30, 2009

(51) Int. Cl. G06F 17/00

(52) U.S. Cl. 700/94

(57) ABSTRACT

A method is provided for identifying and playing back an audio recording including at least a vocal component. The method includes being inputted with sound including at least a vocal component; determining that the inputted sound matches an audio recording; obtaining the audio recording; identifying at least one characteristic of the vocal component of the inputted sound; and playing back the obtained audio recording adapted with the at least one characteristic. An apparatus, such as a mobile terminal, and a computer program are also disclosed.

### TECHNICAL FIELD

The present invention relates to a method for identifying and playing back an audio recording. The invention also relates to an apparatus configured for carrying out such a method and to a computer program configured, when executed on an apparatus, to cause the apparatus to carry out such a method. The apparatus may for instance be a mobile phone.

### BACKGROUND

Methods are known in the art for identifying a sound or piece of music based on a sample thereof, which may differ, to a certain extent, from the original recorded sample. The sample of the sound or piece of music may be sung, hummed, or whistled by a user interacting with an apparatus, such as a mobile terminal, mobile phone or the like.

One method known in the art is described in Jonathan T. Foote, “Content-Based Retrieval of Music and Audio”, Multimedia Storage and Archiving Systems II, Proceedings of SPIE, Vol. 3229, 1997, pp. 138-147. The paper presents a system to retrieve audio documents by acoustic similarity.

Another method is described in international application WO 2007/059420 A2, for non-text-based identification of a selected item of stored music.

Yet another method is described in international application WO 02/27707 A1. The method involves recognizing a melody from a set of stored melodies using two search criteria. The first search criterion is an audio sample representing the melody to be recognized, and the second search criterion comprises at least one word related to the melody to be recognized.

It is desirable to provide improved methods in order to notably provide richer output results to users attempting to identify audio recordings.

### SUMMARY

Such methods, apparatuses and computer programs are defined in the independent claims. Advantageous embodiments are defined in the dependent claims.

In one embodiment of the invention, a method for identifying and playing back an audio recording including at least a vocal component is provided. The method includes a step of being inputted with sound including at least a vocal component; a step of determining that the inputted sound matches an audio recording; a step of obtaining the audio recording; a step of identifying at least one characteristic of the vocal component of the inputted sound; and a step of playing back the obtained audio recording adapted with the at least one characteristic.

In the present context, the operation consisting in identifying an audio recording includes retrieving, or obtaining, a copy of one version of the audio recording, such as for instance a complete copy of the original audio recording, from, i.e. based on and using, a sound including a sample that is similar to a certain extent to a sample of the audio recording to be retrieved. An audio recording including at least a vocal component is an audio recording including at least a sound uttered by a human being or by an animal (such as for instance parrots or other birds that can mimic sounds from their environment, including human voice).

Furthermore, in the present context, determining that the inputted sound matches an audio recording includes determining with a certain degree of confidence or a certain likelihood that the inputted sound was intended to represent the audio recording.

This embodiment of the invention not only provides, to a user having inputted the sound, with the audio recording that is likely to correspond to the inputted sound, but also provides him or her with an adapted version of the obtained audio recording. More specifically, the version of the audio recording is adapted with at least one characteristic of the vocal component of the inputted sound.

If the user used his or her own voice to produce the inputted sound, the user may then be provided with an adapted version of the audio recording being as if, i.e. as it would be if, the user had produced the adapted audio recording with his or her own voice. The adapted version of the audio recording may also, or alternatively, be as if somebody having voice characteristics somewhere between the voice characteristics of the user having inputted the sound and the voice characteristics of the person having produced the audio recording (such as the original singer) had produced the adapted audio recording. Namely, the audio recording may be adapted towards the voice characteristics of the user.

A richer output may then be provided to the user, for educational, entertainment or any other purposes. One possible application includes improving one's singing skills.

In other words, this embodiment may enable a user not only to find out the name of a song that is stuck in his or her head without knowing its title and to actually obtain an audio recording of the song, but the user is provided with more than this. A sample or portion of a song, or speech, is known to the user, uttered by him or her using the apparatus, and the whole song, or speech, is retrieved by the apparatus implementing the method of this embodiment of the invention. Then, the original song or speech, or any other recorded version thereof, is played back in an adapted manner towards the characteristics of the inputted sound including the vocal component of the user (if the user used his or her own voice to produce the inputted sound).

In one embodiment, the method is such that the obtained audio recording includes, on separate tracks, a vocal component and an instrumental component. Furthermore, in this embodiment, the step of playing back the obtained audio recording includes extracting the vocal component of the obtained audio recording; processing the extracted vocal component by adapting it with the at least one characteristic; and replacing in the obtained audio recording the vocal component with the adapted vocal component.

This embodiment enables, when an audio recording to be identified includes both a vocal component and an instrumental component, to easily and conveniently adapt the vocal component of the original obtained audio recording with the at least one characteristic of the vocal component of the inputted sound. In this context, separate tracks may mean for instance separate locations of a data storage unit (such as a flash memory, a RAM, a ROM, a hard drive, or the like) or separate sections of a signal.

In one embodiment, the audio recording is a recorded piece of music. The recorded piece of music may be a song.

In one embodiment, the step of being inputted with sound includes recording, with a microphone, sound including a vocal component to create the inputted song. Therefore, if the method is for instance carried out by a mobile terminal, the user of the mobile terminal may utter, with his or her voice, a sample of a song (for instance) that he or she has in mind, so that the song can be identified and played back. The microphone may be integrated with the mobile terminal or may be a separate microphone. The microphone may be any type of sound recording means adapted to provide the inputted sound to the apparatus configured to carry out the method.

In one embodiment, the step of being inputted with sound includes receiving the sound from a communication network. The communication network may be a wireless network. The communication network may alternatively be a wired network. The communication network may also include both wireless and wired portions. In this embodiment, if the method is carried out by a user terminal, the inputted sound is not necessarily a sound uttered by the user of the user terminal, but may be a sound received from another user located elsewhere, such a user of another mobile terminal.

In one embodiment, the step of obtaining the audio recording (namely the audio recording determined to match the inputted sound) includes downloading the audio recording from a communication network. As mentioned with respect to the previous embodiment, the communication network may be a wireless network, a wired network or a combination thereof. In this embodiment, the plurality of audio recordings which may be identified with the method may be stored in a remote music database server, which is remote with respect to the apparatus configured to carry out the method.

In one embodiment, the step of obtaining the audio recording (namely the audio recording determined to match the inputted sound) includes retrieving the audio recording from a local data storage unit. The local data storage unit may for instance be a flash memory, a RAM, a ROM, a hard drive, or the like. In this embodiment, the plurality of audio recordings which may be identified using the method are stored in the apparatus (such as a mobile terminal for instance) configured to carry out the method. Providing a local music database within the apparatus is advantageous in that it offers fast processing and identification.

In one embodiment, the method include trying to obtain the audio recording using a local music database stored within the apparatus, and, if not successful, trying to obtain the audio recording by querying a remote server storing more audio recordings than stored on the apparatus. This reduces the communications carried over the network, thus saving resources, with due consideration to the limited memory space on the apparatus.

In one embodiment, the at least one characteristic of the vocal component of the inputted sound includes at least one of the pitch, the formants, the tempo, the tone, the volume and the power. Any one of these characteristics of a human voice may be used to adapt the audio recording towards the voice of the user having produced the inputted sound including the vocal component. The method is not however limited to these characteristics. Other characteristics, or combinations thereof, may be used for adapting the audio recording.

In one embodiment, the method is carried out by a mobile terminal. The mobile terminal may for instance be a mobile phone, a portable multimedia player, a game console, a portable computer or laptop, a personal digital assistant (PDA), a smartphone, a pocket PC, a tablet PC, an e-book, or the like.

The invention also relates to an apparatus configured for carrying out a method according to any one of the above-mentioned embodiments.

The invention also relates to an apparatus configured for identifying and playing back an audio recording including at least a vocal component. The apparatus includes an inputting unit configured for being inputted with sound including at least a vocal component; a determining unit configured for determining that the inputted sound matches an audio recording; an obtaining unit configured for obtaining the audio recording; an identifying unit configured for identifying at least one characteristic of the vocal component of the inputted sound; and a playing-back unit configured for playing back the obtained audio recording adapted with the at least one characteristic.

In one embodiment, any one of the above-mentioned apparatuses is a mobile terminal.

The invention also relates to a computer program configured, when executed on an apparatus, to cause the apparatus to carry out any one of the above-mentioned methods.

### BRIEF DESCRIPTION OF THE DRAWINGS

Embodiments of the present invention shall now be described, in conjunction with the appended figures, in which:

FIG. 1 is a flowchart of a method according to one embodiment of the invention;

FIG. 2 schematically illustrates a network configuration involved in a method according to one embodiment of the invention;

FIG. 3 is a flowchart illustrating some details of a step of playing back an audio recording in a method according to one embodiment of the invention;

FIGS. 4a and 4b are flowcharts of some details of a step of being inputted with sound in a method according to two alternative embodiments of the invention; and

FIGS. 5a and 5b are flowcharts of some details of a step of obtaining the audio recording (namely the audio recording determined to match the inputted sound) in a method according to two alternative embodiments of the invention.

### DESCRIPTION OF SOME EMBODIMENTS

The present invention shall now be described in conjunction with specific embodiments. It may be noted that these specific embodiments serve to provide the skilled person with a better understanding, but are not intended to in any way restrict the scope of the invention, which is defined by the appended claims.

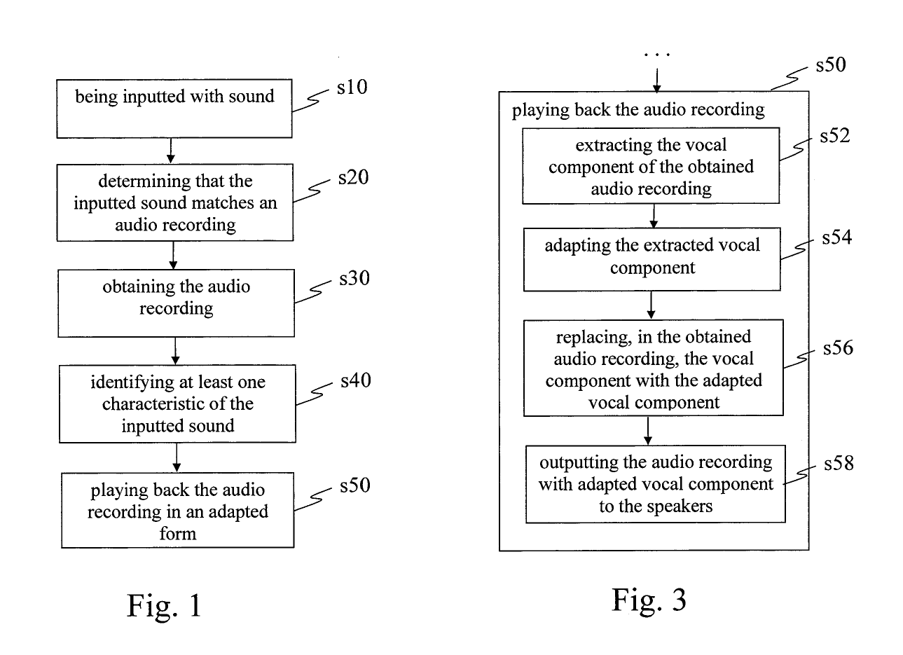

FIG. 1 is a flowchart of a method according to one embodiment of the invention. First, a step s10 of being inputted with sound is carried out. Step s10 may be triggered by the user of the apparatus, such as a mobile terminal, by activating a particular button or function of a user interface.

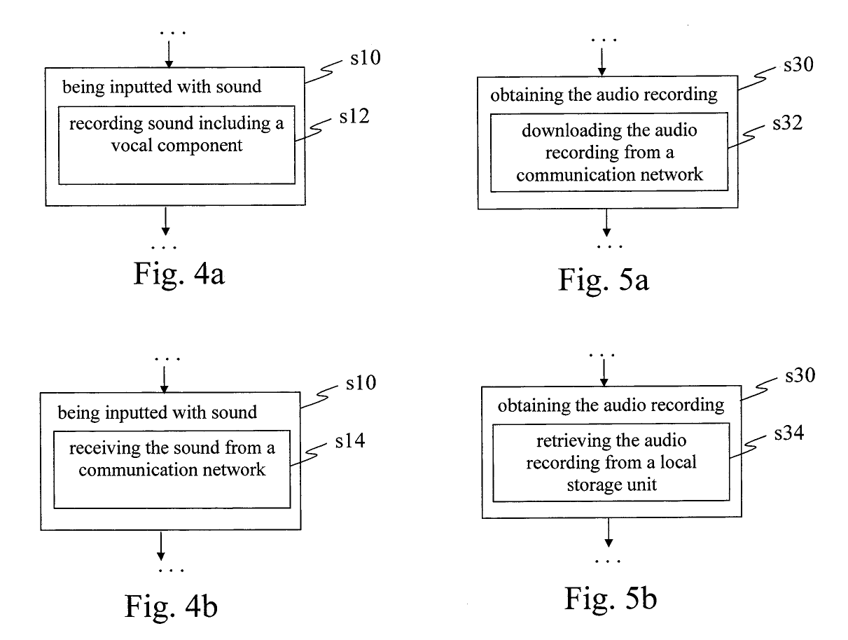

Step s10 may include recording s12 sound including a vocal component using a microphone, as illustrated on the flowchart of FIG. 4a. Alternatively, step s10 of being inputted with sound may include receiving s14 the sound from a communication network, as illustrated in FIG. 4b.

Subsequently, returning to FIG. 1, a step s20 of determining that the inputted sound matches an audio recording is carried out. The method described in Jonathan T. Foote, “Content-Based Retrieval of Music and Audio” (full reference mentioned in the “background” section) or in WO 2007/059420 A2 may for instance be used for implementing step s20. If, at that stage, it is determined that the inputted sound does not match any available audio recording, the user may be informed accordingly through an appropriate message appearing on the user interface. The user may then try to record again sound to identify the audio recording he or she has in mind.

In one embodiment, users are given the opportunity to complement the provision of the sound corresponding to the audio recording to be identified by one or more words related the audio recording they have in mind. This may help the apparatus to find out to which audio recording the inputted sound corresponds. The one or more words related the audio recording they have in mind may be any one of a portion of the title, a portion of the lyrics, the name of the singer or band, and the like.

If an audio recording has been identified, a step s30 of obtaining the audio recording is then carried out.

Step s30 of obtaining the audio recording may include downloading s32 the audio recording from a communication network 80, as illustrated in FIG. 5a. Alternatively, step s30 of obtaining the audio recording may include retrieving s34 the audio recording from a local storage unit, as illustrated in FIG. 5b.

Returning to FIG. 1, a step s40 of identifying at least one characteristic of the inputted sound is then carried out.

The audio recording is then played back s50 in an adapted form. The adaptation of the audio recording is based on, i.e. is carried out using, the one or more identified or selected characteristics of the inputted sound.

It follows that the sound inputted in step s10, such as for instance the sound uttered by a user's voice, is used for two purposes. First, the inputted sound is used for identifying the audio recording in step s20 and, secondly, the inputted sound is used for adapting or customizing the audio recording to be played back in step s50.

In this context, the sound inputted by the user in step s10 (which is the input material available for analysis of the user's voice characteristics) is particularly well suited to modify the characteristics of (i.e., to adapt) the identified and obtained audio recording, because the type of sound available from the user's voice generally corresponds (same words, similar tempo, etc.) to the type of sound in the identified and obtained audio recording. The steps of the method therefore synergistically contribute to the improvement provided over the prior art. In other words, the combined technical effect of the method is greater than the sum of the technical effects of its individual steps.

In one embodiment, after step s20 or after step s30, the user is requested in an intermediate step (not illustrated) to confirm that the audio recording he or she had in mind corresponds to the one which has been determined to match the inputted sound, or which has been determined to match the inputted sound and has been obtained.

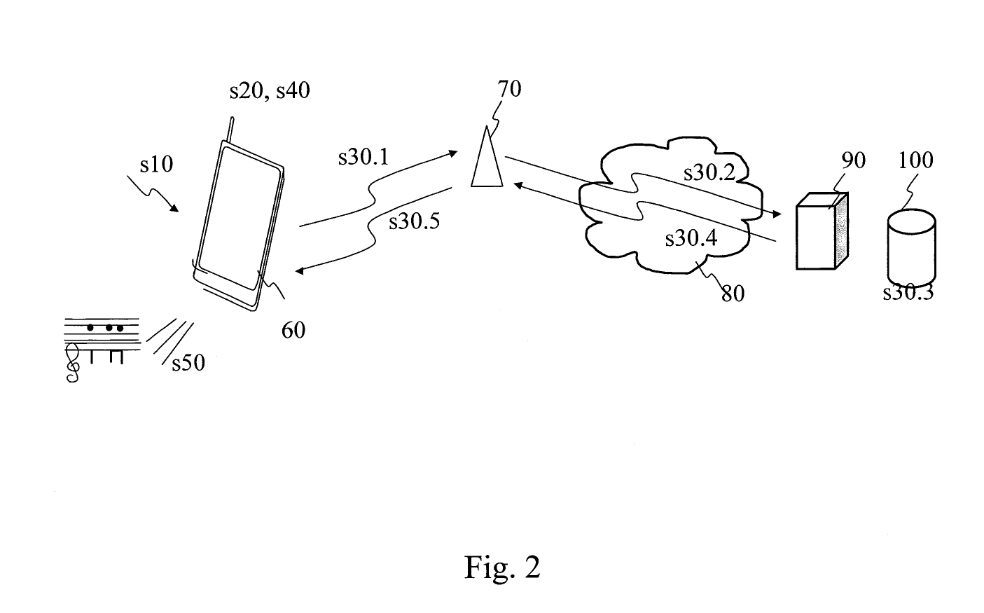

FIG. 2 schematically illustrates a network configuration in which a method according to one embodiment of the invention may be carried out.

Sound is inputted s10 to a mobile terminal 60. The user inputting the sound is not illustrated. The sound may also be inputted s10 by receiving a sound file or stream from a communication network as explained with reference to FIG. 4b. Then, the mobile terminal 60 determines s20 whether the inputted sound matches an audio recording. If a match is found, the mobile terminal 60 sends s30.1 to a base station 70 a query to obtain, and in particular to download, the identified audio recording. The query is forwarded s30.2 through the communication network 80 to a server 90 which retrieves s30.3 in a database 100 the identified audio recording. The audio recording is then sent back s30.4, s30.5 to the mobile terminal 60 through the base station 70.

The mobile terminal 60 then identifies s40 at least one characteristic of the inputted sound. Step s40 may alternatively be performed before step s30, before step s20, or in parallel to steps s20 and s30. In other words, the order of steps in the flowchart of FIG. 1 may be altered.

The mobile terminal 60 then adapts the downloaded audio recording based on the identified characteristic of the inputted sound. The adapted audio recording is then played back s50 in an adapted form.

As mentioned above, step s20 of determining that the inputted sound matches an audio recording may be carried out in the mobile terminal 60. This does not necessarily require however that all the complete audio recordings are stored in the mobile terminal 60. The determining step s20 may be performed based on signatures of audio recordings stored in mobile terminal 60. A signature means in this context a distinguishing aspect, feature, mark or characteristic of an audio recording or a distinguishing set of aspects, features, marks or characteristics of an audio recording. The determining step s20 may also be performed based on excerpts of audio recordings stored in mobile terminal 60, while the complete audio recordings are stored remotely on a server 90, 100.

Alternatively, step s20 of determining whether the inputted sound matches an audio recording may be carried out by a remote server 90 rather than in the mobile terminal 60. In that case, the inputted sound is transmitted to the base station 70 and through the network 80 to the server 90. Obtaining s30 the audio recording therefore includes receiving the identified audio recording by the mobile terminal 60 from the server 90.

In one embodiment, the most requested audio recordings may be prefetched on the mobile terminal 60 to improve the speed and efficiency of the method.

In one embodiment, the audio recordings are obtained s30 in the form of video clips. Playing back s50 the audio recording may include showing a video clip including the audio recording on the mobile terminal's screen with the adapted sound track.

The network configuration illustrated in FIG. 2 is illustrative of one possible configuration. Other types of configurations involving wired or wireless connections, multiple interconnected networks, and so on may be used in embodiments of the invention.

FIG. 3 is a flowchart illustrating some details of the step of playing back s50 the audio recording in a method according to one embodiment of the invention. In this embodiment, the obtained audio recording includes, on separate or separable tracks, a vocal component and an instrumental component. First, the vocal component of the obtained audio recording is extracted s52. The extracted vocal component is then adapted s54. Finally, the vocal component in the obtained audio recording is replaced s56 with the adapted vocal component. The audio recording including the adapted vocal component may then be outputted s58 to the speakers. The audio recording including the adapted vocal component may also be, or may additionally be, recorded in memory for later use or for sending it on the communication networks to other users.

The obtained audio recording may also include, on separate or separable tracks, a main vocal component (of the lead singer) and one or more remaining components including, possibly, secondary vocal components (e.g., of a choir), instrumental components, background sound, and so on. The step of replacing s56 then includes replacing the main vocal component.

In one embodiment, the obtained audio recording includes predetermined characteristics (pre-analyzed characteristic) of the original singer's vocal characteristics to ease the adaptation processing.

The at least one characteristic of the vocal component of the inputted sound may include at least one of the pitch, the formants, the tempo, the tone, the volume and the power. The invention is not limited to these characteristics though, and other measurable characteristics (i.e., non-subjective characteristics) may be selected to be used as input for the adapting step s54. Furthermore, how much of the original vocal component (of the original singer) and how much of the user's vocal component (of the inputted sound) are included into the adapted audio recording may be determined in advance (e.g., in the memory of the mobile terminal) or may be parameterized by the user (using a user interface's menu). Which characteristics to use for adapting s54 the audio recording may also be determined in advance or parameterizable by the user.

The physical entities according to the invention and/or its embodiments, including the inputting unit, the determining unit, the obtaining unit, the identifying unit, and the playing-back unit, may comprise or store computer programs including instructions such that, when the computer programs are executed on the physical entities, steps, procedures and functions of these units are carried out according to embodiments of the invention. The invention also relates to such computer programs for carrying out the function of the units, and to any computer-readable medium storing the computer programs for carrying out methods according to the invention.

Where the terms “inputting unit”, “determining unit”, “obtaining unit”, “identifying unit” and “playing-back unit” are used in the present document, no restriction is made regarding how distributed these elements may be and regarding how gathered these elements may be. That is, the constituent elements of the above inputting units, determining units, obtaining units, identifying units, and playing-back units may be distributed in different software or hardware components or devices for bringing about the intended function. A plurality of distinct elements or units may also be gathered for providing the intended functionalities.

Any one of the above-referred units may be implemented in hardware, software, field-programmable gate array (FPGA), application-specific integrated circuit (ASICs), firmware or the like.

In further embodiments of the invention, any one of the above-mentioned and/or claimed inputting units, determining units, obtaining units, identifying units and playing-back units is replaced by inputting means, determining means, obtaining means, identifying means and playing-back means respectively, or by an inputter, a determiner, an obtainer, an identifier, a player respectively, for performing the functions of the inputting units, determining units, obtaining units, identifying units and playing-back units.

In further embodiments of the invention, any one of the above-described steps may be implemented using computer-readable instructions, for instance in the form of computer-understandable procedures, methods or the like, in any kind of computer languages, and/or in the form of embedded software on firmware, integrated circuits or the like.

Although the present invention has been described on the basis of detailed examples, the detailed examples only serve to provide the skilled person with a better understanding, and are not intended to limit the scope of the invention. The scope of the invention is much rather defined by the appended claims.

1. Method for identifying and playing back an audio recording including at least a vocal component, the method including
being inputted with sound including at least a vocal component;
determining that the inputted sound matches an audio recording;
obtaining the audio recording;
identifying at least one characteristic of the vocal component of the inputted sound; and
playing back the obtained audio recording adapted with the at least one characteristic.

2. Method of claim 1, wherein
the obtained audio recording includes, on separate tracks, a vocal component and an instrumental component; and
the step of playing back the obtained audio recording includes
extracting the vocal component of the obtained audio recording;
processing the extracted vocal component by adapting it with the at least one characteristic; and
replacing in the obtained audio recording the vocal component with the adapted vocal component.

3. Method of claim 1, wherein the audio recording is a recorded piece of music.

4. Method according to claim 1, wherein the step of being inputted with sound includes recording, with a microphone, sound including a vocal component to create the inputted sound.

5. Method according to claim 1, wherein the step of being inputted with sound includes receiving the sound from a communication network.

6. Method according to claim 1, wherein the step of obtaining the audio recording includes downloading the audio recording from a communication network.

7. Method according to claim 1, wherein the step of obtaining the audio recording includes retrieving the audio recording from a local data storage unit.

8. Method according to claim 1, wherein the at least one characteristic of the vocal component of the inputted sound includes at least one of the pitch, the formants, the tempo, the tone, the volume and the power.

9. Method according to claim 1, the method being carried out by a mobile terminal.

10. Apparatus configured for carrying out the method according to claim 1.

11. Apparatus of claim 10, being a mobile terminal.

12. Computer program configured, when executed on an apparatus, to cause the apparatus to carry out the method according to claim 1.
